(19) United States
(12) Patent Application Publication
(10) Pub. No.: US 2026/0137230 A1
(43) Pub. Date: May 21, 2026

(54) AUTOMATIC DOOR LOCK DEVICE AND PRESSURE STEAM OVEN

(71) Applicant: GUANGDONG XINBAO ELECTRICAL APPLIANCES HOLDINGS CO., LTD., Foshan (CN)

(72) Inventors: Jiangang GUO, Foshan (CN); Qingbin ZENG, Foshan (CN); Bin XIAO, Foshan (CN)

(21) Appl. No.: 19/445,758

(22) Filed: Jan. 12, 2026

Related U.S. Application Data
(63) Continuation of application No. PCT/CN2024/136613, filed on Dec. 4, 2024.

(30) Foreign Application Priority Data
Dec. 7, 2023 (CN) 202311677297.0

(51) Int. Cl. A47J 27/08; A47J 27/04

(52) U.S. Cl. CPC A47J 27/0804; A47J 27/04; A47J 2027/043

(57) ABSTRACT

The present invention provides an automatic door lock device and a pressure steam oven. The automatic door lock device includes: a latch, arranged on an inner side of a door body of the pressure steam oven; an engaging part, arranged on an oven body of the pressure steam oven, where when the door body is closed, the engaging part is pushed to rotate in a first direction and is engaged into the latch, and when the door body is opened, the engaging part rotates in a second direction and is disengaged from the latch; an elastic part, arranged on the oven body; and a locking part, arranged on the oven body. According to the present invention, primary tensioning and locking may be adopted during pressureless cooking, and secondary tensioning and locking may be added during pressure cooking, so that the safety in use is guaranteed.

### CROSS-REFERENCE TO RELATED APPLICATIONS

This application is a continuation of International Application No. PCT/CN2024/136613, filed on December 4, 2024, which claims priority to Chinese Patent Application No. 202311677297.0, filed on December 7, 2023, both of which are hereby incorporated by reference in their entireties.

### TECHNICAL FIELD

The present invention belongs to the technical field of household appliances, in particular to an automatic door lock device and a pressure steam oven.

### BACKGROUND

With the improvement of the living standard, steam ovens have become increasingly popular. The steam ovens can be used to bake bread slices, roast meat, and steam and bake food, thus being well received by the majority of customers. With the advancement of science and technology and the acceleration of the pace of life, the control of people on time is strengthened, and the requirement for the taste of cooked food is improved. To save the trouble caused by long cooking time and poor taste of some food, pressure steam ovens emerge to accelerate food cooking and improve the taste of cooked food in the presence of a pressure, and food can also be well cooked under a low pressure. Due to the increase in the pressure in the steam oven, many problems arise. To increase the pressure in a cavity of the steam oven, sealing of the cavity and the increase and decrease in the pressure in the cavity become challenges in the industry. An existing conventional door structure cannot realize complete closing of a door, resulting in steam leakage and making the pressure fail to satisfy requirements. To achieve door sealing, some products adopt a double door lock, which not only is complex in structure, high in cost and difficult to assemble, but also is inconvenient to operate and leads to poor user experience of the pressure steam oven. In view of this, the structure of the existing pressure steam oven needs to be further optimized.

For example, Chinese Patent Authorization Publication No. CN210144465U discloses a pressure steam oven and a door lock device and water supply device thereof. The door lock device includes a handle, a cam, a hinge, buckles and latches, where the buckles are arranged on a top wall of an inner container and are in one-to-one correspondence with the latches; the handle is rotated to drive the hinge to move in the horizontal direction by means of the cam so as to drive the buckles to move in the circumferential direction to be engaged with or disengaged from the latches. However, a door body cannot be further tightened, manual operation is needed, and the door opening operation and mechanism are complex.

### SUMMARY

In view of the above-mentioned problems in the prior art, an objective of the embodiments of the present invention is to provide an automatic door lock device, which is simple in structure and easy to operate, can achieve secondary tensioning and locking, and guarantees the locking effect.

The technical solution adopted by the embodiments of the present invention is as follows: An automatic door lock device is applied to a pressure steam oven and includes:

a latch, arranged on an inner side of a door body of the pressure steam oven;

an engaging part, arranged on an oven body of the pressure steam oven and rotatable with respect to the oven body, where when the door body is closed, the engaging part is pushed to rotate in a first direction and is engaged in the latch, and when the door body is opened, the engaging part rotates in a second direction opposite to the first direction and is disengaged from the latch;

an elastic part, arranged on the oven body, acting on the engaging part and used for applying, to the engaging part, an acting force for enabling the engaging part to rotate in the first direction to tighten the latch when the door body is closed, and applying, to the engaging part, an acting force for enabling the engaging part to rotate in the second direction, so as to enable the engaging part to rotate and be maintained in an initial state when the door body is opened; and

a locking part, arranged on the oven body and used for stopping the engaging part to prevent the engaging part from rotating in the second direction when a pressure in the oven body reaches a first threshold, so that a lock applies, to the latch, a locking force towards an interior of the oven body.

In an optional embodiment, the engaging part includes a rotary lever and the lock arranged on the rotary lever, and the rotary lever is rotationally connected to the oven body; when the door body is closed, the lock is engaged in the latch; when the door body is opened, the lock is disengaged from the latch; the locking part is started when the pressure in the oven body reaches the first threshold and stops the rotary lever. The engaging part is reasonable in structural arrangement, and the door body may be locked and unlocked easily by means of the lock and the rotary lever for driving the lock to rotate.

In an optional embodiment, the rotary lever includes a rotary connection portion as well as a first lever body and a second lever body which extend out from the rotary connection portion, the rotary lever is rotationally connected to the oven body by means of the rotary connection portion, a free end of the first lever body forms the lock, and a free end of the second lever body is used for stopping the locking part. The structure is simple and reasonable, and the using effect is good.

In an optional embodiment, the locking part includes a telescopic rod; when the pressure in the oven body reaches the first threshold, the telescopic rod stretches out towards the second lever body and is located in front of the second lever body in the second direction to prevent the rotary lever from rotating in the second direction. The telescopic rod is used to stop the second lever body, so that the structure is simple and implementation is easy.

In an optional embodiment, a slope is arranged at the free end of the second lever body; when the telescopic rod stretches out, the slope abuts against the telescopic rod to enable the telescopic rod to apply, to the second lever body by means of the slope, an acting force for enabling the second lever body to rotate in the first direction, so that the lock tightens the latch towards the interior of the oven body; when the telescopic rod stretches out in place, the telescopic rod crosses over the slope and stops the second lever body; when the steam pressure in the oven body pushes the door body outwards, the rotary lever is driven to tend to rotate in the second direction, and the second lever body applies a pressure to the telescopic rod to implement double locking.

In an optional embodiment, the locking part further includes an electromagnet fixed to the oven body, and the telescopic rod penetrates through the electromagnet; when the electromagnet is powered on or off, the telescopic rod stretches out towards the rotary lever; when the electromagnet is powered off or on, the telescopic rod retracts. The telescopic rod may be easily controlled to stretch and retract by means of the electromagnet, the control precision is high, and the safety in use is improved.

In an optional embodiment, the locking part further includes a motor and a cam which is arranged on an output shaft of the motor and rotates with the output shaft; when the cam rotates, the cam pushes the telescopic rod to stretch out towards the rotary lever or stops pushing the telescopic rod to allow the telescopic rod to retract and give way for rotation of the rotary lever.

In an optional embodiment, the locking part further includes a reset part and a microswitch, and the reset part has an end connected to the oven body as well as an end connected to the telescopic rod and is used for applying, to the telescopic rod, an acting force for enabling the telescopic rod to return to a retracted state; the microswitch is arranged on the oven body and electrically connected to the motor, and when the telescopic rod stretches out in place towards the rotary lever under the action of the cam, the microswitch is triggered to stop the motor and at the same time, drive the reset part to stretch to accumulate elastic potential energy.

In an optional embodiment, the elastic part includes a torsion spring, and the torsion spring has an end arranged on the rotary lever as well as an end arranged on the oven body.

The embodiments of the present invention further provide a pressure steam oven, including an oven body and a door body, where a cooking cavity is formed in the oven body, the oven body is provided with an oven opening connected to the cooking cavity, and the door body is used for opening or closing the oven opening. The pressure steam oven further includes the automatic door lock device in any one of the above embodiments. According to the pressure steam oven, the cooking cavity of the oven body may be sealed by the door body both in the presence of a pressure and in the absence of a pressure, so that the food cooking speed is increased, the taste of cooked food is improved, and user experience is improved.

In an optional embodiment, the pressure steam oven further includes a convection fan device, where the convection fan device includes a convection fan, convection blades, a convection blade housing and a first sealing ring, the convection fan is fixed to the oven body, the convection blade housing is arranged outside the convection blades and used for separating the convection fan from the convection blades, an output shaft of the convection fan penetrates through the convection blade housing to be connected to the convection blades and is used for driving the convection blades to rotate, the convection blades, when rotating, drive hot air in the oven body to circulate, the first sealing ring is disposed around the output shaft and has an end abutting against the convection blade housing as well as an end abutting against a fan body of the convection fan. By means of the first sealing ring, a sealing effect is realized, and steam in the oven body is prevented from overflowing via the position where the output shaft penetrates through the convection blade housing.

In an optional embodiment, the pressure steam oven further includes a second sealing ring, where the second sealing ring includes a ring-shaped main portion and at least one lip portion extending out from the main portion; in the presence of multiple lip portions, the multiple lip portions are sequentially connected to form a Z shape, an end of the innermost lip portion is connected to the main portion, a reinforcing structure is arranged on the outermost lip portion, and a thickness of the outermost lip portion is greater than that of the other lip portions; a circular groove is formed in a periphery of the oven opening of the oven, the main portion is arranged in the circular groove and provided with hollow structures which are spaced apart from each other, so that the main portion is able to deform to be fixed in the circular groove; when the door body is closed, the outermost lip portion abuts against an inner side of the door body. The structure is reasonable, and the sealing effect is good.

In an optional embodiment, the pressure steam oven further includes a steam discharging and pressure relief device, where the steam discharging and pressure relief device includes a steam valve, a steam discharging part, a pressure relief part, a steam discharging line, a pressure relief line and a steam inlet line, the steam discharging line has an end connected to an outlet of the steam valve as well as an end provided with the steam discharging part, the steam inlet line has an end connected to an inlet of the steam valve as well as an end connected to one end of the pressure relief line, the other end of the pressure relief line is provided with the pressure relief part, and a steam inlet connected to an interior of the oven body is formed in the steam inlet line;

in a case where a pressure cooking mode of the pressure steam oven is not enabled, the steam valve is powered off and is in an on state, the steam inlet line is connected to the steam discharging line, and steam in the oven body is discharged by means of the steam discharging part;

in a case where the pressure cooking mode of the pressure steam oven is enabled, the steam valve is powered on and is in an off state, the steam inlet line is disconnected from the steam discharging line, and the steam in the oven body is discharged by means of the pressure relief part when reaching a set pressure.

In an optional embodiment, the pressure steam oven further includes an evaporation device, where the evaporation device is arranged at a bottom of an interior of the oven body, and an evaporation surface of the evaporation device is lower than a bottom surface of the interior of the oven body. In this way, condensate water may be easily collected and evaporated, and the usage experience of users is improved.

Compared with the prior art, the embodiments of the present invention have the following beneficial effects: according to the automatic door lock device provided by the present invention, normal door opening, closing and locking may be realized during pressureless cooking, and during pressure cooking, the door body may be further tightened on the basis of original locking to realize secondary tensioning and locking, thus guaranteeing the sealing performance of the door body. The structure is simple, the assembly difficulty is low, operation is convenient, and implementation is easy.

It should be understood that the above general description and the following detailed description are both illustrative and explanatory rather than being used for limiting the present invention.

The introduction of various implementations or examples of the technique described here is not a comprehensive disclosure of the overall scope or all features of the technique.

### BRIEF DESCRIPTION OF THE DRAWINGS

In the drawings that are not definitely drawn to scale, identical reference signs may describe similar components in different views. The drawings approximately illustrate various embodiments by way of examples rather than in a restrictive manner and are used to describe the embodiments of the present disclosure together with the specification and claims. In appropriate circumstances, reference signs in the drawings indicate identical or similar components.

FIG. 1 is a schematic diagram of an internal structure of a pressure steam oven according to one embodiment of the present invention.

FIG. 2 is a schematic structural diagram of the pressure steam oven in an open state according to one embodiment of the present invention.

FIG. 3 is an enlarged view of part A in FIG. 2.

FIG. 4 is a schematic structural diagram of the pressure steam oven in a pressureless closed state according to one embodiment of the present invention.

FIG. 5 is an enlarged view of part B in FIG. 4.

FIG. 6 is a schematic structural diagram of interaction of a telescopic rod and a second lever body according to one embodiment of the present invention.

FIG. 7 is a schematic partial structural diagram of the pressure steam oven in a pressure closed state according to one embodiment of the present invention.

FIGS. 8-10 are respectively schematic structural diagrams of an engaging part in another form in a state where the engaging part is located in different positions according to one embodiment of the present invention.

FIG. 11 is a schematic diagram of a motion trajectory of a highest point of a cam and a motion trajectory of an end of a rotary lever according to one embodiment of the present invention.

FIG. 12 is a schematic structural diagram of a convection fan device according to one embodiment of the present invention.

FIG. 13 is a sectional view of assembly of a sealing ring according to one embodiment of the present invention.

FIGS. 14-16 are respectively schematic structural diagrams of the sealing ring according to one embodiment of the present invention.

FIG. 17 is a schematic structural diagram of a steam discharging and pressure relief device according to embodiment of the present invention.

FIG. 18 is a cooking logic diagram of the pressure steam oven according to one embodiment of the present invention.

### Reference signs:

1, latch;

2, engaging part; 21, rotary lever; 211, rotary connection portion; 212, first lever body; 213, second lever body; 2131, slope; 22, lock;

3, elastic part;

4, locking part; 41, telescopic rod; 42, electromagnet; 43, motor; 44, motor holder; 45, cam; 46, reset part; 47, microswitch; 48, contact;

100, oven body; 101, circular groove; 102, rotary shaft; 103, control module; 104, support plate;

200, door body; 201, second sealing ring; 2011, main portion; 2012, hollow structure; 2013, first lip portion; 2014, second lip portion; 2015, reinforcing rib;

300, convection fan device; 301, convection fan; 302, convection blade; 303, convection blade housing; 304, first sealing ring;

401, steam valve; 402, steam discharging part; 403, pressure relief part; 404, steam discharging line; 405, pressure relief line; 406, steam inlet line;

500, steam supply device; 501, steam line; 600, heating device; 700, water supply device; 800, cooling device; 900, evaporation device.

### DESCRIPTION OF EMBODIMENTS

To better clarify the objectives, technical solutions and advantages of the embodiments of the present invention, the technical solutions in the embodiments of the present invention are clearly and completely described below in conjunction with accompanying drawings of the embodiments of the present invention. Obviously, the embodiments described below are merely illustrative ones rather than all possible ones of the present invention. All other embodiments obtained by those ordinarily skilled in the art based on the following ones without creative labor should also fall within the protection scope of the present invention.

Unless otherwise defined, technical or scientific terms used here should be construed as having the same meaning as commonly understood by those ordinarily skilled in the art. The term “first” or “second” and similar expressions used here do not indicate any sequence, number or importance and are merely used for distinguishing different components. The term such as “comprise” or “include” indicates that an element or article in front of the term contains an element or article behind the term and equivalents thereof, without excluding other elements or articles. “Connect”, “link” or similar terms are not limited to physical or mechanical connection and may include electrical connection, either directly or indirectly. Terms such as “upper”, “lower”, “left” and “right” merely indicate a relative positional relation, and when the absolute position of an object described changes, the relative positional relation will change accordingly.

For the sake of a clear and brief description of the embodiments of the present invention, known functions and components are not detailed in the present invention.

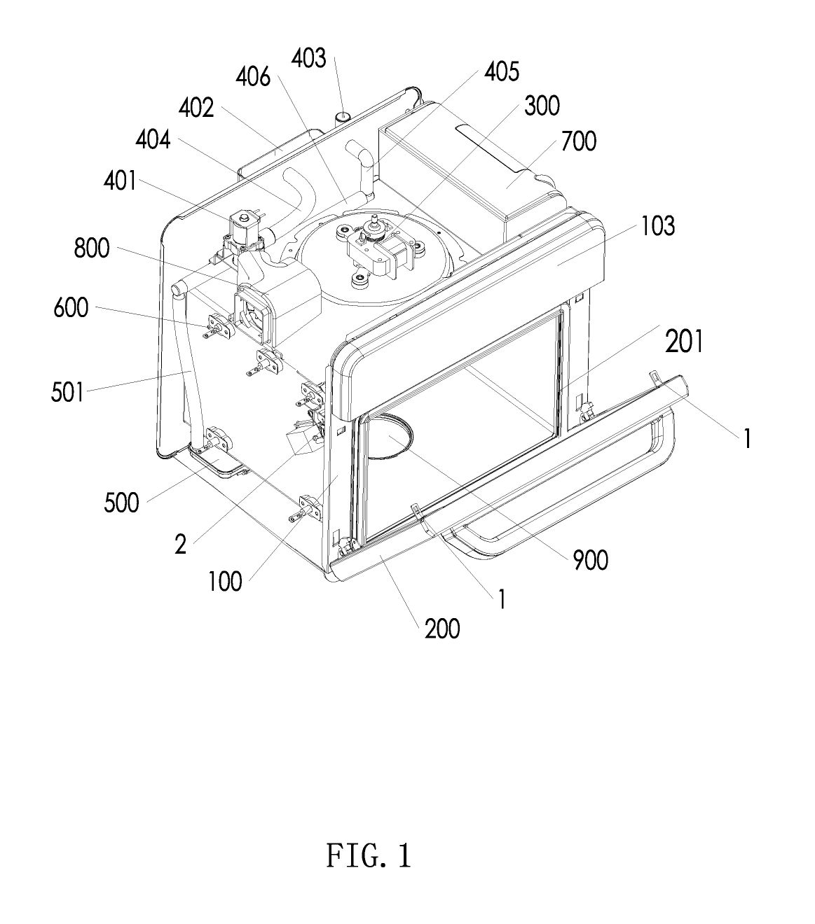

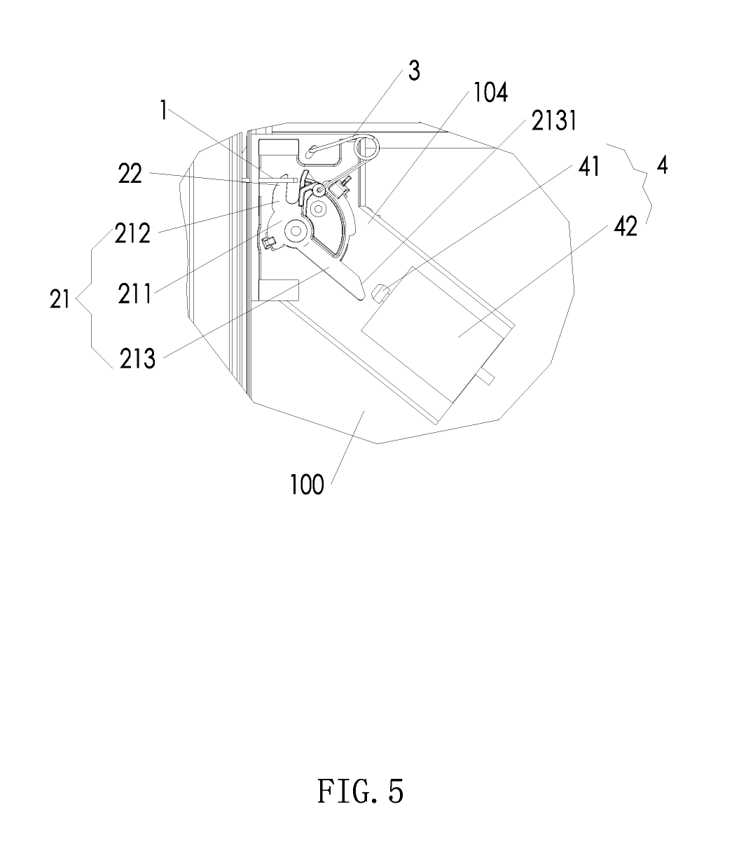

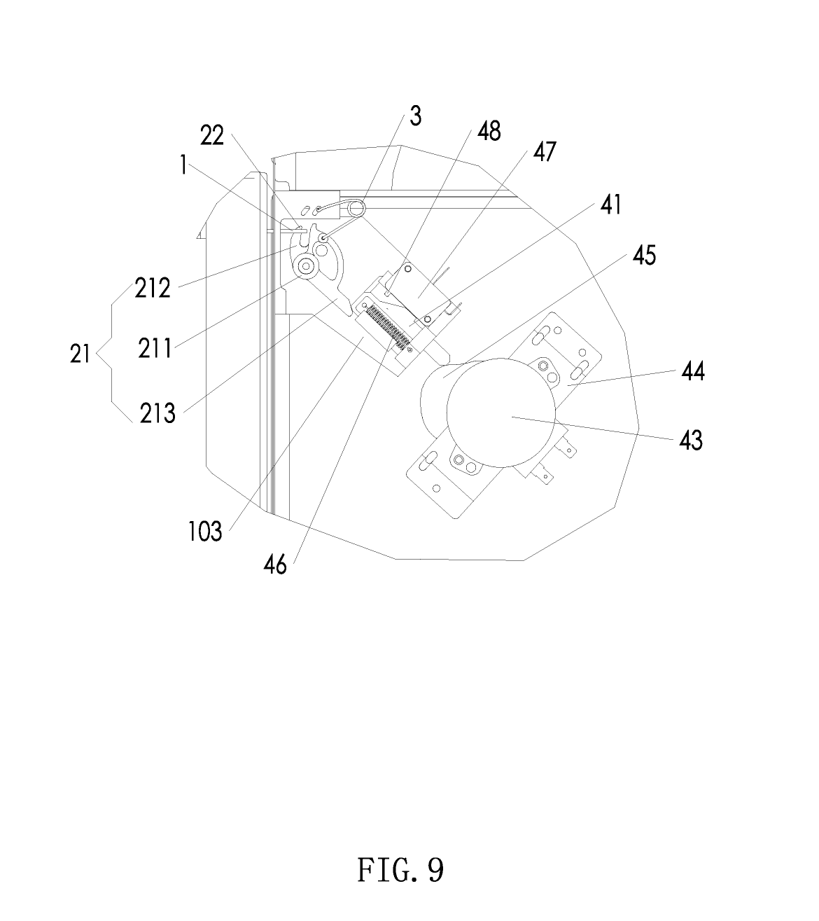

As shown in FIGS. 1-11, one embodiment of the present invention provides an automatic door lock device, which is applied to a pressure steam oven. The automatic door lock device mainly includes a latch 1, an engaging part 2, an elastic part 3 and a locking part 4.

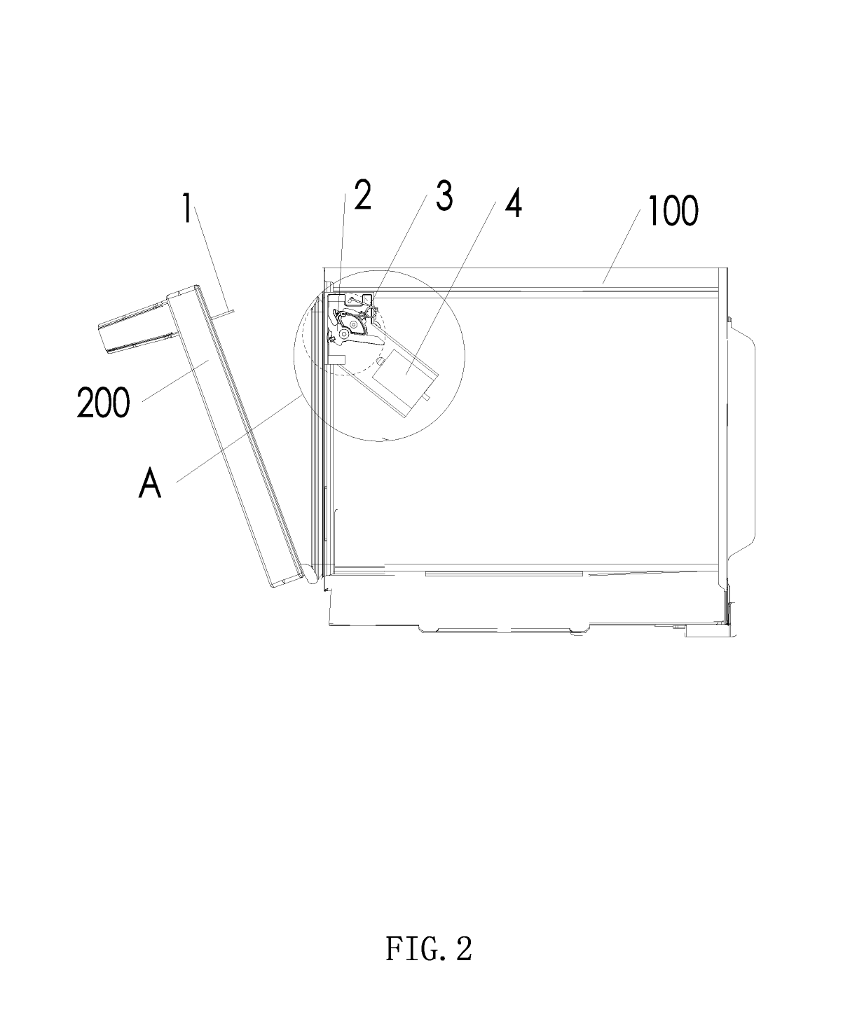

As shown in FIGS. 1 and 2, the latch 1 is arranged on an inner side of a door body 200 of the pressure steam oven.

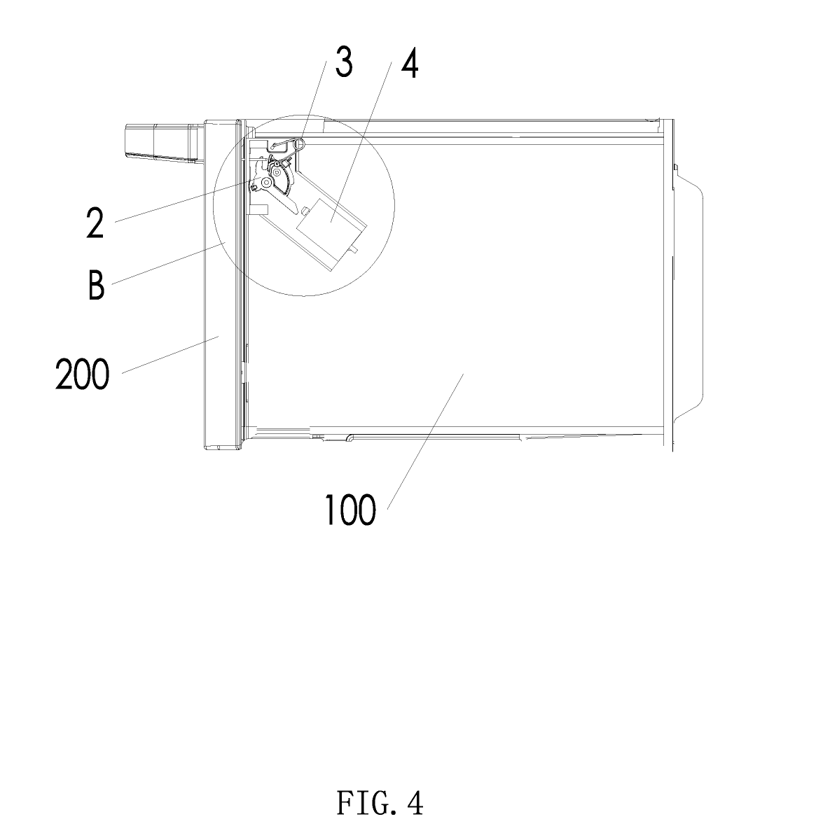

As shown in FIGS. 2 and 4, the engaging part 2 is arranged on an oven body 100 of the pressure steam oven and is rotatable with respect to the oven body 100. When the door body 200 is closed, the engaging part 2 is pushed by the door body 200 to rotate in a first direction to be engaged into the latch 1, so that the door body 200 is locked on the oven body 100 to realize a locking function. When the door body 200 is opened, the engaging part 2 rotates in a second direction opposite to the first direction and is disengaged from the latch 1, that is, the latch 1 is unlocked by the engaging part 2, so that the door body 200 is allowed to be opened with respect to the oven body 100.

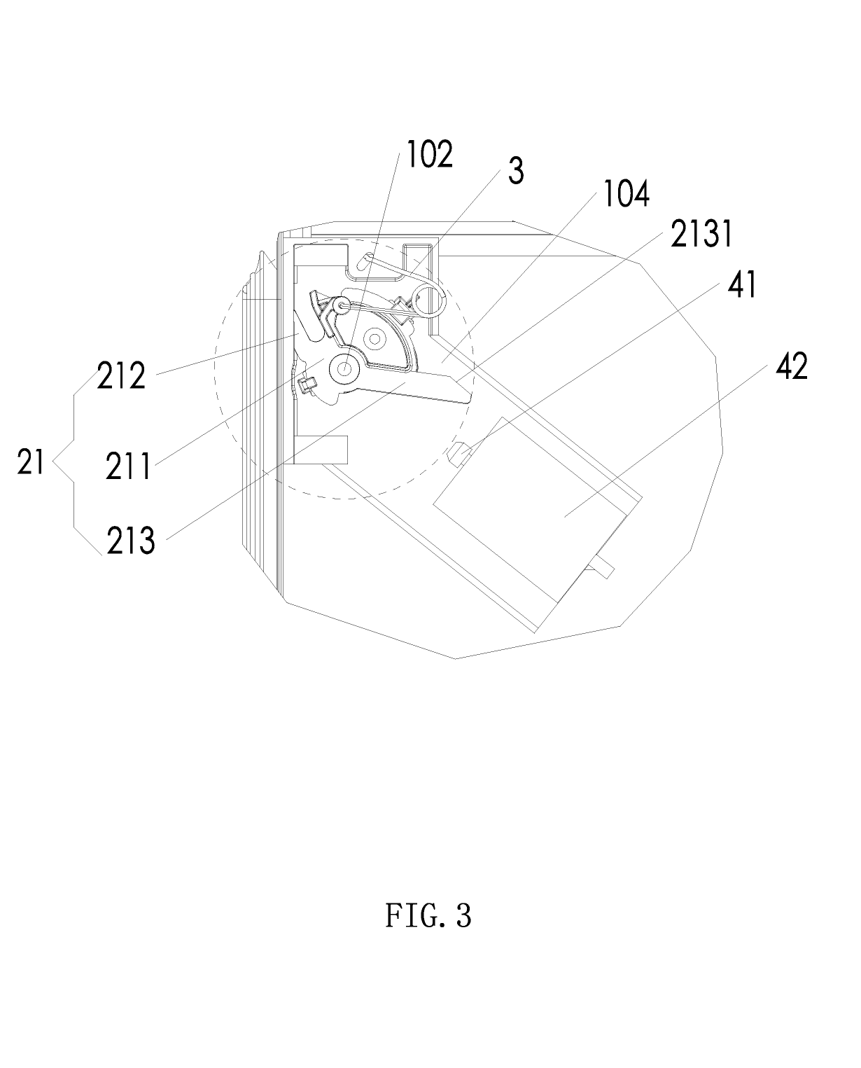

As shown in FIGS. 3, 5 and 7, the elastic part 3 is arranged on the oven body 100, acts on the engaging part 2, and is used for applying, to the engaging part 2, an acting force for enabling the engaging part 2 to rotate in the first direction to tighten the latch 1 when the door body 200 is closed, and applying to, the engaging part 2, an acting force for enabling the engaging part 2 to rotate in the second direction, so as to enable the engaging part 2 to rotate and be maintained in an initial state when the door body 200 is opened.

As shown in FIGS. 2 and 4, the locking part 4 is arranged on the oven body 100 and used for stopping the engaging part 2 to prevent the engaging part 2 from rotating in the second direction when a pressure in the oven body 100 reaches a first threshold, so that a lock 22 applies, to the latch 1, a locking force towards an interior of the oven body 100.

According to the automatic door lock device provided by the embodiments of the present invention, primary locking may be realized during pressureless operation of the pressure steam oven, and secondary locking may be realized during pressure operation of the pressure steam oven, so that the door body 200 is sealed both in the presence of a pressure in the oven body 100 and in the absence of a pressure in the oven body 100.

During pressureless operation of the pressure steam oven, when the door body 200 is closed, the engaging part 2 is engaged in the latch 1 on the door body 200 to realize a locking function, and the locking part 4 is not started. During pressure operation of the pressure steam oven, when the door body 200 is closed, the engaging part 2 is engaged in the latch 1 on the door body 200 to realize a primary locking function; steam is generated in the oven body 100 due to cooking, and when the pressure in the oven body 100 gradually increases to the first threshold, a thrust is applied to the door body 200 to enable the door body 200 to tend to be opened outwards, the latch 1 on the door body 200 pulls the engaging part 2 to enable the engaging part 2 to tend to rotate in the second direction, and at this moment, the locking part 4 is started and stops the engaging part 2 to prevent the locking part 2 from rotating in the second direction, such that a double locking effect is realized, and the double locking force will increase with the increase in the steam pressure in the oven body 100. That is, in a case where a pressure cooking mode of the pressure steam oven is enabled, the door body 200 is further tightened on the basis of original locking to realize secondary locking, thus guaranteeing the sealing performance of the door body 200.

In some embodiments, as shown in FIGS. 3, 5 and 7, the engaging part 2 includes a rotary lever 21 and the lock 22 arranged on the rotary lever 21, where the rotary lever 21 is rotationally connected to the oven body 100. When the door body 200 is closed, the lock 22 is engaged in the latch 1. When the door body 200 is opened, the lock 22 is disengaged from the latch 1. When the pressure in the oven body 100 reaches the first threshold, the locking part 4 is started and stops the rotary lever 21. The engaging part 2 is reasonable in structure, and by means of the lock 22 and the rotary lever 21 for driving the locks 22 to rotate, the door body 200 may be easily locked and unlocked.

The structure for rotationally arranging the rotary lever 21 on the oven body 100 is not limited. For example, a shaft hole may be formed in the rotary lever 21, a rotary shaft 102 is fixed to the door body 100, and the rotary lever 21 is mounted on the rotary shaft 102 by means of the shaft hole. The latch 1 on the door body 200 may be a structure, which sticks out of the inner side of the door body 200 and is provided with an engaging hole. When the door body 200 is closed, the latch 1 on the door body 200 stretches into the oven body 100, and the lock 22 is pushed to drive the rotary lever 21 to rotate synchronously in the first direction, and the lock 22 is accordingly engaged in the engaging hole of the latch 1 to lock the door body 200, thus realizing the locking function. When the door body 200 is pulled outwards, the latch 1 is driven by the door body 200 to move towards the exterior of the oven body 100 synchronously, the latch 1 drives the lock 22 and the rotary lever 21 to rotate synchronously in the second direction, and the lock 22 is disengaged from the latch 1 in the rotation process, thus realizing the unlocking function. During pressure operation of the pressure steam oven, when the locking part 4 is started, the rotary lever 21 is stopped by the locking part 4 to be prevented from rotating in the second direction, so that the lock 22 will not be disengaged from the latch 1 and apply, to the latch 1, an acting force towards the interior of the oven body 100 to implement double locking, thus preventing the door body 200 from being opened under the action of the pressure in the oven body 100 in the cooking process.

In some embodiments, further referring to FIGS. 3, 5 and 7, the rotary lever 21 includes a rotary connection portion 211 as well as a first lever body 212 and a second lever body 213 which extend out from the rotary connection portion 211. A shaft hole is formed in the rotary connection portion, and the rotary lever 21 is rotationally connected to a rotary shaft 102 on the oven body 100 by means of the rotary connection portion 211. It may be understood that both the rotary lever 21 and the lock 22 rotate with the rotary shaft 102 as a center of rotation. A free end of the first lever body 212 forms the lock 22, and a free end of the second lever body 213 is used for stopping the locking part 4. The rotary lever 21 is reasonable in structural design, secondary locking is realized by cooperation between one lever body and the locking part 4, and the lock 22 is formed by means of the other lever body, so that the structure is simplified, and the structural stability is improved.

The angle between the first lever body 212 and the second lever body 213 is not limited. To be matched with the latch 1 and the locking part 4 and facilitate the arrangement of parts, the angle a between the first lever body 212 and the second lever body 213 may be greater than 90° and less than 180°. The angle a is an angle formed from the first lever body 212 to the second lever body 213 in the first direction.

As shown in FIGS. 3, 5 and 7, the first lever body 212 may be slightly bent in the second direction on the whole to form the lock 22 which is approximately in a hook shape; or, the free end of the first lever body 212 may be bent to be in a hook shape to form the lock 22. The lock 22 in such a shape may be easily engaged into or disengaged from a locking hole of the latch 1, thus making locking and unlocking easy to implement.

In some embodiments, the locking part 4 includes a telescopic rod 41. When the pressure in the oven body 100 reaches the first threshold, the telescopic rod 41 stretches out towards the second lever body 213 and is located in front of the second lever body 213 in the second direction to prevent the rotary lever 21 from rotating in the second direction. The telescopic rod 41 is used to stop the second lever body 213, so that the structure is simple, and implementation is easy.

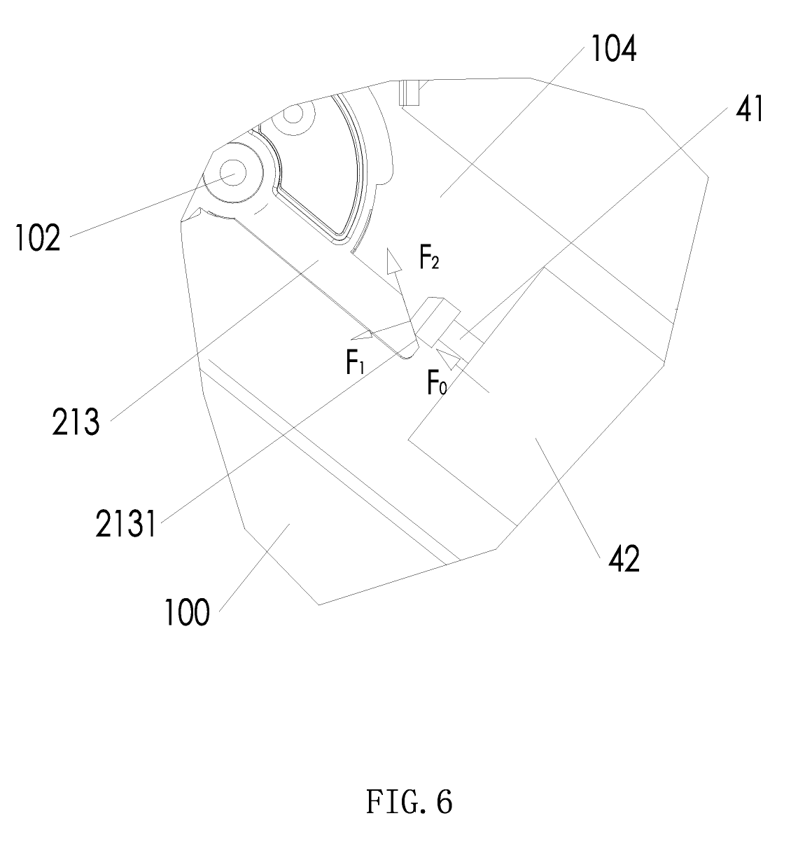

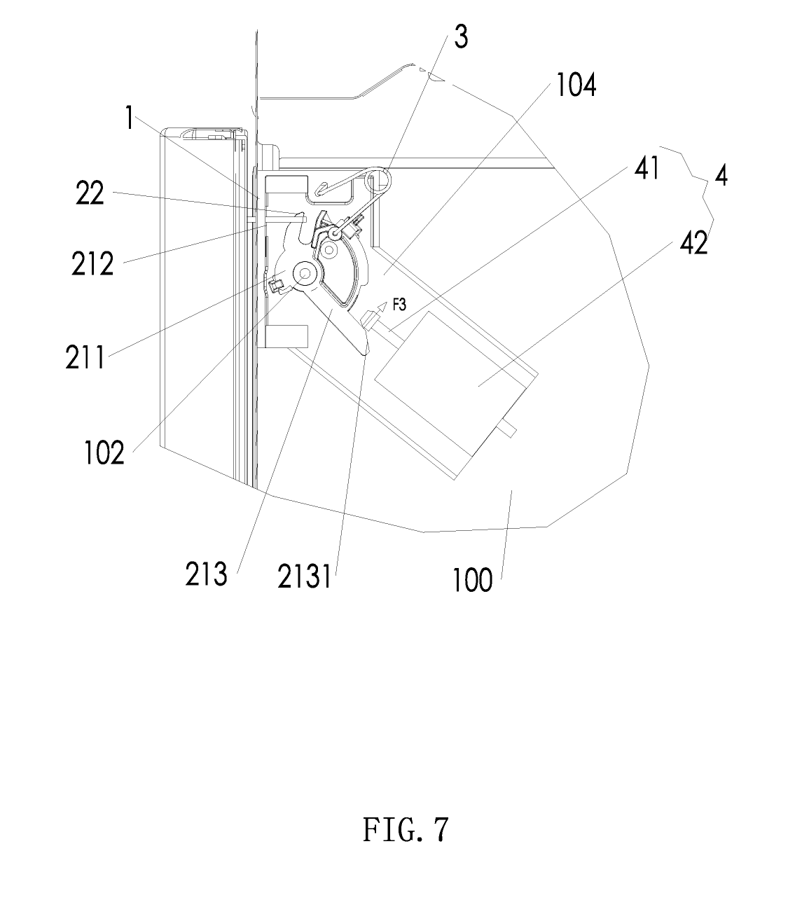

In some embodiments, as shown in FIGS. 3, 5 and 7, a slope 2131 is arranged at the free end of the second lever body 213. When the telescopic rod 41 stretches out, the slope 2131 abuts against the telescopic rod 41 to enable the telescopic rod 41 to apply, to the second lever body 213 by means of the slope 2131, an acting force for enabling the second lever body 213 to rotate in the first direction (see FIG. 6), so that the lock 22 tightens the latch 10 towards the interior of the oven body 100; when the telescopic rod 41 stretches out in place (when the telescopic rod 41 stretches out to a final state and cannot further stretch out, the telescopic rod 41 stretches out in place, and at this moment, the telescopic rod 41 has a maximum length), the telescopic rod 41 crosses over the slope 2131 and stops the second lever body 213 (see FIG. 7); in this state, when the steam pressure in the oven body 100 pushes the door body 200 outwards, the rotary lever 21 is driven to tend to rotate in the second direction, and the second lever body 213 applies a pressure to the telescopic rod 41 to implement double locking.

In a case where the pressure cooking mode of the pressure steam oven is enabled, as shown in FIG. 6, the telescopic rod 41, when stretching out, first acts on the slope 2131 of the second lever body 213 and applies a force F0 to the slope 2131, the force F0 is broken up into a thrust F1 and a force in an F2 direction, and the thrust F1 pushes the rotary lever 21 and the lock 22 on the rotary lever 21 to rotate around the center of rotation to tighten the latch 1, so that the door body 200 is further tightened on the basis of original locking, thus realizing a secondary locking effect.

When the telescopic rod 41 reaches the position in FIG. 7, steam is generated in the oven body 100 due to cooking, the pressure in the oven body 100 increases slowly to apply an outward thrust to the door body 200, and the thrust drives the rotary lever 21 to rotate in the second direction by means of the lock 22, so that the rotary lever 21 applies a shear force F3 to the telescopic rod 41 by means of the second lever body 213 (the direction of the shear force F3 is shown in FIG. 7) to prevent the door body 200 from moving outwards, and the frictional force on a contact surface, abutting against the second lever body 213, of the telescopic rod 41 is increased to prevent the telescopic rod 41 from retracting uncontrollably (a failure of control), thus realizing a double locking effect.

The telescopic rod 41 may be controlled to stretch and retract in various ways, for example, by electric control or mechanical control, which is not specifically limited here as long as the telescopic rod 41 is controlled to stretch towards the second lever body 213 to stop the second lever body 213 so as to prevent the rotary lever 21 from rotating in the second direction when the pressure in the oven body 100 reaches the first threshold.

In some embodiments, as shown in FIGS. 3, 5 and 7, the locking part 4 further includes an electromagnet 42 fixed to the oven body 100. The telescopic rod 41 penetrates through the electromagnet 42. When the electromagnet 42 is powered on or off, the telescopic rod 41 stretches out towards the rotary lever 21. When the electromagnet 42 is powered off or on, the telescopic rod 41 retracts. By means of the electromagnet 42, the telescopic rod 41 may be controlled to stretch and retract conveniently, the control precision is high, and the safety in use is improved.

Illustratively, the telescopic rod 41 may include a rod portion, a head arranged at a protruding end of the rod portion and a stop portion arranged at a tail end of the rod portion, where the rod portion penetrates through the electromagnet 42, the head and the stop portion are located outside two opposite ends of the electromagnet 42 respectively, and the elastic part 3 is arranged between the stop portion and the electromagnet 42 and used for applying, to the stop portion, an acting force for enabling the stop portion to move in a direction away from the electromagnet 42. The elastic part 3 may be a spring, which is disposed around the rod portion and has two ends respectively abutting against the stop portion and one end of the electromagnet 42. The stop portion is made from a ferromagnetic material. When the electromagnet 42 is electrified (powered on), a current is generated in a coil of the electromagnet 42 and forms a magnetic field around the coil, the electromagnet 42 attracts the stop portion, the stop portion drives the whole rod portion and the head to move towards the second lever body 213 in an axial direction of the rod portion, and at the same time, the stop portion pushes the spring, so that the spring is compressed to accumulate elastic potential energy. When the electromagnet 42 is de-electrified (powered off), the magnetic force of the electromagnet 42 disappears, the stop portion is driven by the spring to move in a direction away from the second lever body 213, the telescopic rod 41 retracts into the electromagnet 42, the rotation of the rotary lever 21 will not be hindered by the head of the electromagnet 42 (see FIG. 3, in which the dotted line indicates a maximum rotation path of the rotary lever 21 and the head of the electromagnet 42 is located outside the dotted line), and the spring is in a naturally stretched state.

In some embodiments, the elastic part 3 includes a torsion spring, where one end of the torsion spring is arranged on the rotary lever 21, and the other end of the torsion spring 21 is arranged on the oven body 100. The torsion spring is always in a compressed state, that is, no matter whether the door body 200 is opened and the rotary lever 21 is in an initial state or the door body 200 is closed and the rotary lever 21 is in a locking state, the torsion spring is maintained in the compressed state.

When the door body 200 is closed, the latch 1 on the door body 200 pushes the rotary lever 21 to rotate around the center of rotation (the rotary shaft 102) to engage the lock 22 into the latch 1, and under the action of the torsion spring, the lock 22 applies a tightening force to the latch 1 to realize locking. That is to say, the torsion spring and the rotary lever 21 work together to tighten and lock the door body 200. When the door body 200 is opened, the rotary lever 21 is maintained in the initial state under the action of the torsion spring.

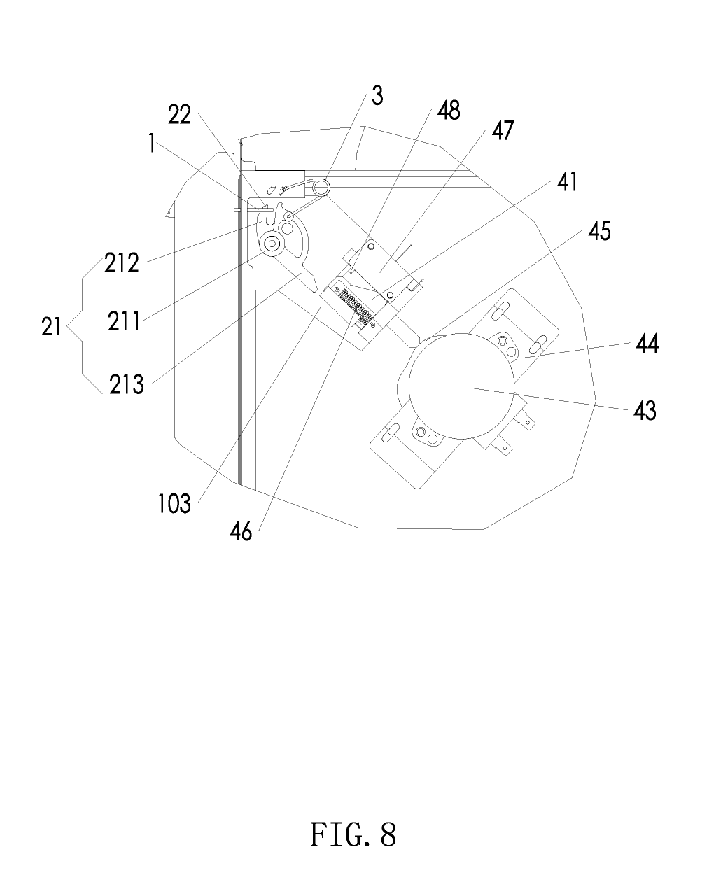

In addition to the electromagnet 42, the telescopic rod 41 may also be driven to stretch and retract by means of a motor 43 and a cam 45, as shown in FIGS. 8-11. In the case where the telescopic rod 41 is controlled to stretch and retract by means of the motor 43 and the cam and in the case where the telescopic rod 41 is controlled to stretch and retract by means of the electromagnet 42, the motion trajectories of the telescopic rod 41 are the same, and the stress conditions of the telescopic rod 41 and the second lever body 213 are also the same.

Specifically, as shown in FIGS. 8-11, the locking part 2 not only includes the telescopic rod 41, but also includes the motor 43 and the cam 45 which is arranged on an output shaft of the motor 43 and rotates with the output shaft. The cam 45, when rotating, pushes the telescopic rod 41 to stretch out towards the rotary lever 21 or stops pushing the telescopic rod 41 to allow the telescopic rod 41 to retract to give way for rotation of the rotary lever 21. The structure for driving the telescopic rod 41 by means of the motor 43 and the cam 45 is simple and easy to implement.

The telescopic rod 41 may be arranged on a support plate 103. Specifically, a limiting structure for limiting the telescopic rod 41 on the support plate 104 is arranged on the support plate 104. The limiting structure prevents the telescopic rod 41 from being separated from the support plate 104 and will not restrain stretching and retraction of the telescopic rod 41 in the axial direction. The motor 43 is fixed to a motor holder 44, and the motor holder 44 may be fixed to the oven body 100.

In some embodiments, further referring to FIGS. 8-11, the locking part 4 further includes a reset part 46 and a microswitch 47, where one end of the reset part 46 is connected to the oven body 10 and to be specific, may be connected to the support plate 104 of the oven body 100, the other end of the reset part 46 is connected to the telescopic rod 41, and the reset part 46 is used for applying, to the telescopic rod 41, an acting force for enabling the telescopic rod 41 to retract. For example, the reset part 46 may be a tension spring. The microswitch 47 is arranged on the oven body 100 and electrically connected to the motor 43. Specifically, the microswitch 47 may be arranged on the support plate 104 of the oven body 100 and is close to the telescopic rod 41. When the telescopic rod 41 stretches out in place towards the rotary lever 21 under the action of the cam 45 and stops the second lever body 213, the telescopic rod 41 triggers the microswitch 47 to stop the motor 43, and the telescopic rod 41 stretches out and at the same time, drives the reset part 46 to stretch to accumulate elastic potential energy. The telescopic rod 41, when stretching out in place, not only stops the rotary lever 21, but also triggers the microswitch 47 to stop the motor 43 to enable the cam 45 to push the telescopic rod 41, so that the structural design is ingenious, the structure and the control program are simplified, and using is more convenient.

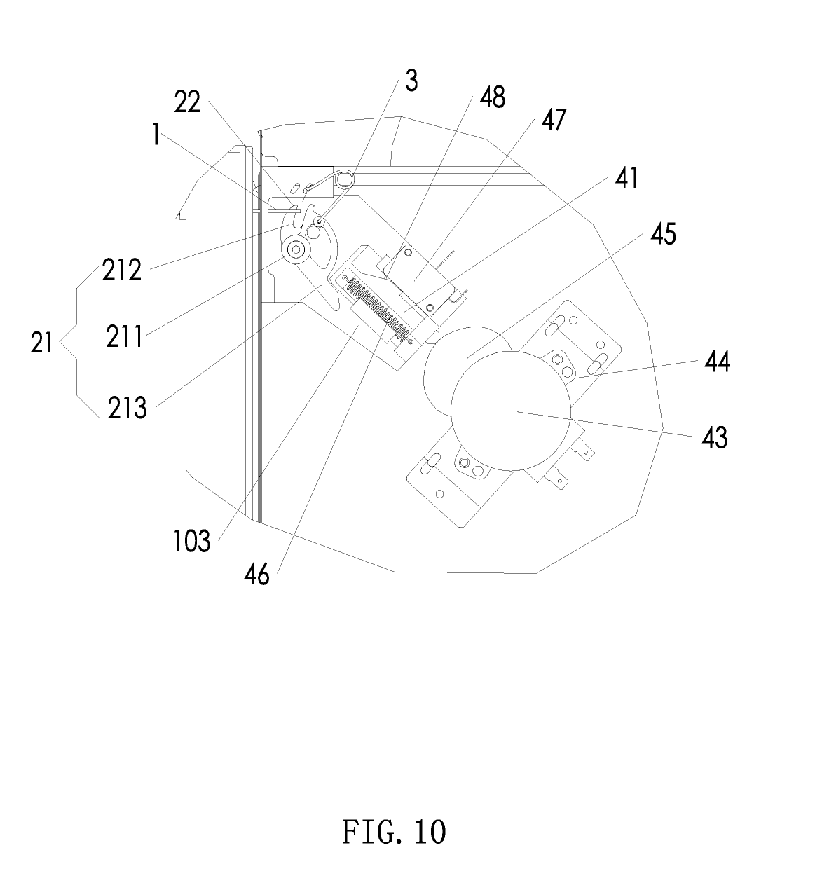

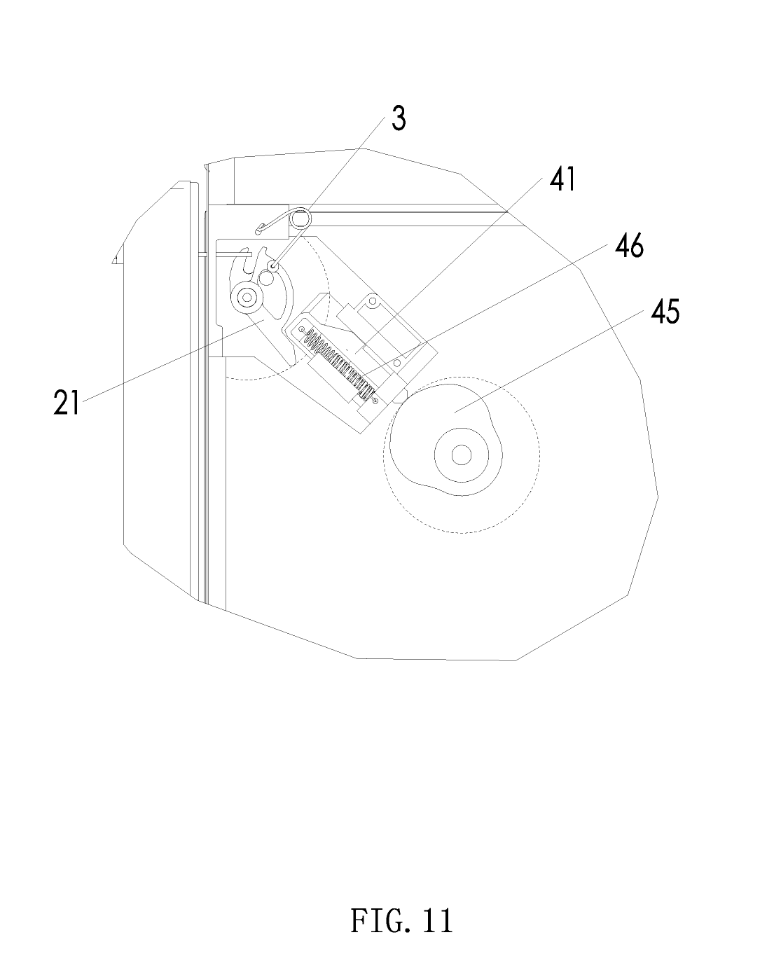

When the motor 43 is started to drive a convex portion of the cam 45 to rotate to correspond to the telescopic rod 41, the telescopic rod 41 will be pushed to stretch out gradually towards the rotary lever 21; when the cam 45 rotates to a highest point to push the telescopic rod 41 (see FIG. 10), the telescopic rod 41 stretches out in place, stops the second lever body 213 of the rotary lever 21 and at the same time, touches a contact 48 of the microswitch 47 to trigger the microswitch 47. As shown in FIG. 11, the dotted line above indicates a motion trajectory of one end of the rotary lever 21 (i.e., a motion trajectory of the free end of the second lever body 213), and the dotted line below indicates a motion trajectory of the highest point of the cam 45. When the cam 45 moves to the highest point to push the telescopic rod 41, the telescopic rod 41 stretches out in place and stops the second lever body 213. After cooking is ended, the motor 43 continues to rotate or rotates reversely, the convex portion of the cam 45 gradually rotates away from the telescopic rod 41, and a concave portion of the cam 45 corresponds to the telescopic rod 41, so that the cam 45 stops pushing the telescopic rod 41 and will not hinder the rotation of the rotary lever 21 (see FIG. 8).

Illustratively, the microswitch 47 is arranged beside the telescopic rod 41, and the contact 48 of the microswitch 47 stretches out towards the telescopic rod 41. The outer diameter of the telescopic rod 41 increases gradually from the end facing the rotary lever 21 to the other end of the telescopic rod 41, so that the circumferential surface of the telescopic rod 41 forms a slope. When the telescopic rod 41 stretches out in place towards the rotary lever 21, the slope on the telescopic rod 41 touches the contact 48 of the microswitch 47 to trigger the microswitch 47.

After cooking is ended, the motor 43 is controlled to rotate and drives the cam 45 to rotate, the reset part 46 pulls the telescopic rod 41 to move in a direction away from the rotary lever 21 to return to the retracted state, the microswitch 47 is no longer triggered by the telescopic rod 41, timing is started at the moment the telescopic rod 41 leaves the contact of the microswitch 47, and when the telescopic rod 41 returns to the position shown in FIG. 8, the motor 43 stops.

The microswitch 47 may be connected in series to a circuit where the motor 43 is located. When the telescopic rod 41 triggers the microswitch 47, the circuit is closed, and the motor 43 drives the cam 45 to rotate. The microswitch 47 may also be electrically connected to a control module 103 of the pressure steam oven, the microswitch 47, when triggered, sends a signal to the control module 103, and the control module, when receiving the signal, controls the motor 43 to stop. The control module 103 is able to receive a pressure signal of the oven body 100. When the pressure in the oven body 100 reaches the first threshold or a first preset time later after the pressure steam oven is started, it is considered that the pressure in the oven body 100 reaches the first threshold, and the control module 103 controls the motor 43 to start.

The working principle of the automatic door lock device in the embodiments of the present invention is as follows:

In a case where the pressure cooking mode is not enabled, the pressure in the oven body 100 is normal, the locking part 4 is not started, and the telescopic rod 41 is in the retracted state and will not stop the rotary lever 21 from rotating, the lock 22 on the rotary lever 21 tightens and locks the door body 200, and the door body 200 may be normally opened and closed.

In a case where the pressure cooking mode is enabled, when the pressure in the oven body 100 reaches the first threshold, the control module 103 of the pressure steam oven controls the electromagnet 42 to be electrified, the telescopic rod 41 stretches out towards the second lever body 213, and the lock 22 tightens and locks the door body 200; when the pressure in the oven body 100 is released after cooking, the control module 103 controls the electromagnet 42 to be de-electrified, the telescopic rod 41 retracts, the second lever body 213 is no longer limited, and the rotary lever 21 is allowed to rotate, and the door body 200 may be opened and closed normally.

One embodiment of the present invention further provides a pressure steam oven. As shown in FIG. 1, the pressure steam oven includes an oven body 100 and a door body 200, where a cooking cavity is formed in the oven body 100, the oven body 100 is provided with an oven opening connected to the cooking cavity, and the door body 200 is used for opening or closing the oven opening. The pressure steam oven further includes the automatic door lock device in any one of the above embodiments.

In the embodiments of the present invention, the pressure steam oven includes the automatic door lock device and thus has a primary tensioning and locking function during pressureless cooking and a secondary tensioning and locking function during pressure cooking, thus ensuring that the cooking cavity in the oven body 100 is sealed by the door body 200 both in the presence of a pressure in the cooking cavity and in the absence of a pressure in the cooking cavity. The food cooking speed is increased, the taste of cooked food is improved, and user experience is improved.

Other parts (the engaging part 2 and the locking part 4), rather than the latch 1, of the automatic door lock device may be fixed to an inner wall of the oven body 100 by means of screws. To improve firmness and prevent damage to the side wall of the oven body 100, a support plate 104 may be arranged on the inner wall of the oven body 100, and the automatic door lock device is arranged on the inner wall of the oven body 100 by means of the support plate 104.

The door body 200 is connected to the oven body 100 by means of a bottom hinge, and the door body 200 is able to rotate with respect to the hinge by a specific angle to open or close the oven body 100. As shown in FIG. 1, two latches 1 may be arranged on the door body 200, and the two latches 1 are respectively located at the top of the inner side of the door body 200 and spaced apart from each other. Similarly, two engaging parts 2 and two locking parts 4, which respectively correspond to the two latches 1, are arranged in the oven body 100. In this way, when the door body 200 is closed, the door body 200 may be stably locked on the oven body 100. In some embodiments, the locking part 4 may be electrically connected to a control module 103 on the pressure steam oven, and the locking part 4 be controlled to act or not by means of a program. For example, a cooking time is set, and a first preset time later after the pressure steam oven is started, it is considered that the pressure in the cooking cavity reaches a first threshold, the control module 103 sends a starting signal to the locking part 4, and the locking part 4 is started to stop the engaging part 2.

In the case where the locking part 4 includes the electromagnet 42 and the telescopic rod 41, the control module 103 may control the electromagnet 42 to be powered on or off. The first preset later after the pressure steam oven is started or when it is detected by a pressure detection part, arranged in the cooking cavity, that the pressure in the cooking cavity reaches the first threshold, the control module 103 controls a circuit, where the electromagnet 42 is located, to be closed, at this moment, the electromagnet 42 is powered on, the telescopic rod 42 stretches out and stops the second lever body 213 to prevent the rotary lever 21 form rotating in the second direction.

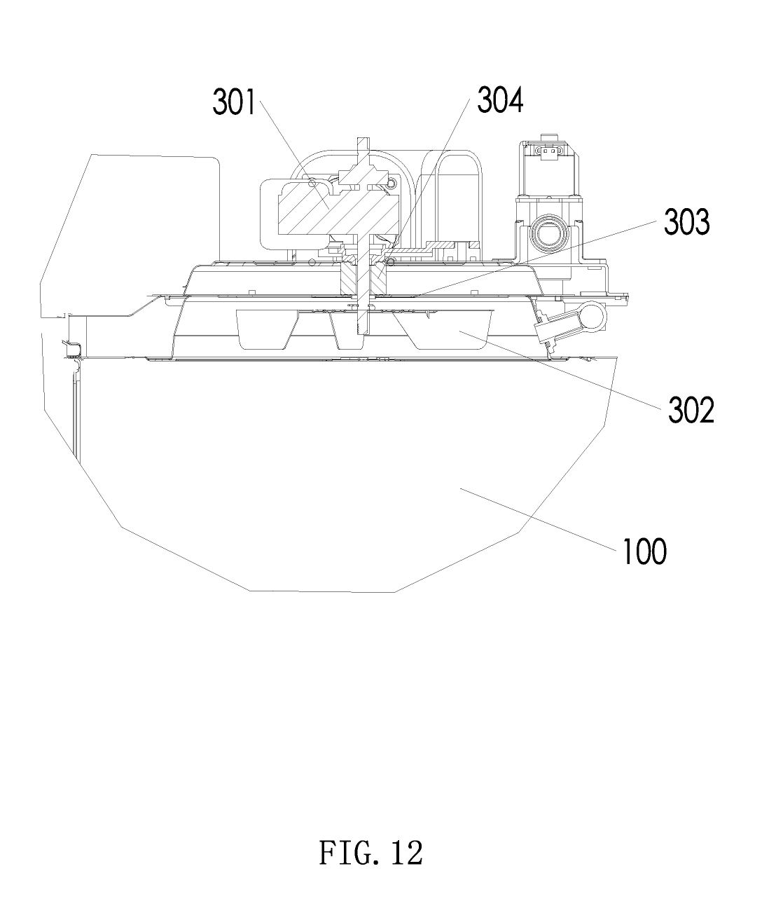

In some embodiments, as shown in FIG. 12, the pressure steam oven further includes a convection fan device 300. The convection fan device 300 includes a convection fan 301, convection blades 302, a convection blade housing 303 and a first sealing ring 304. The convection fan 301 is fixed to the oven body 100, for example, at the top of the oven body 100. The convection blade housing 303 is arranged outside the convection blades 303 and used for separating the convection fan 301 from the convection blades 302. An output shaft of the convection fan 301 penetrates through the convection blade housing 303 to be connected to the convection blades 302 and is used for driving the convection blades 302 to rotate. The convection blades 302, when rotating, drive hot air in the oven body 100 (the cooking cavity) to circulate. The first sealing ring 304 is disposed around the output shaft, one end of the first sealing ring 304 abuts against the convection blade housing 303, and the other end of the first sealing ring 304 abuts against a fan body of the convection fan 301. The two ends of the first sealing ring 304 are respectively in interference fit with the convection blade housing 303 and the fan body of the convection fan 301 (here, the fan body refers to all portions except the output shaft, including a housing) to fulfill a sealing effect, so that steam in the oven body 100 is prevented from overflowing via the position where the output shaft penetrates through the convection blade housing 303.

In some embodiments, as shown in FIG. 1, the pressure steam oven further includes a second sealing ring 201. The second sealing ring 201 is arranged on the periphery of the inner side of the door body 200 or on the periphery of the oven opening of the oven body 100, and used for sealing between the door body 200 and the oven body 100 when the door body 200 is closed, so that a sealed space of the oven body 100 by the cooking cavity in the oven body 100 to realize pressure cooking, thus guaranteeing the cooking effect.

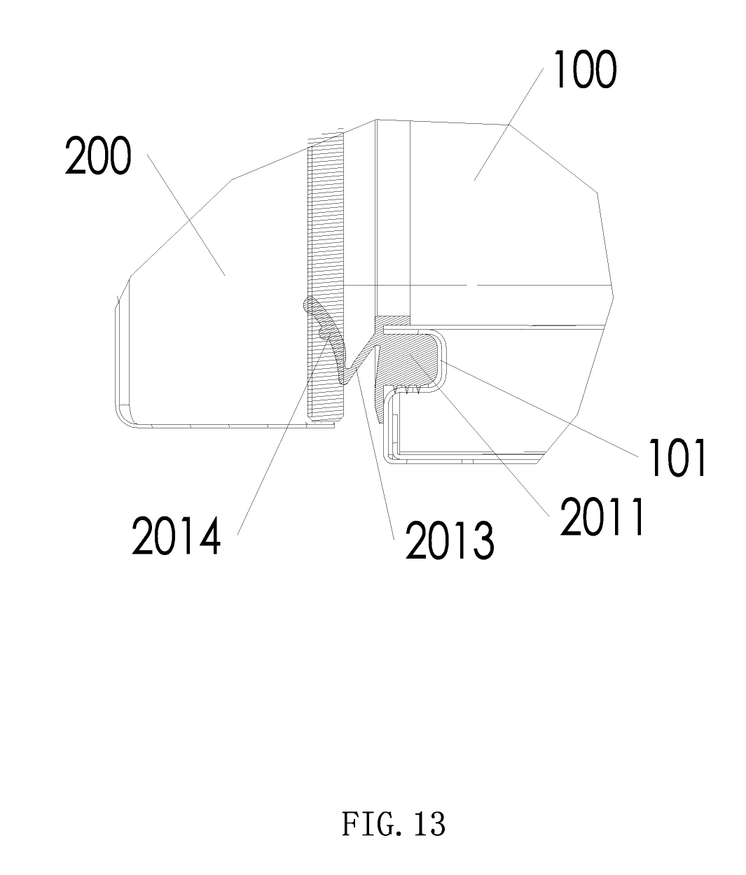

Illustratively, as shown in FIGS. 13-16, the second sealing ring 201 includes a ring-shaped main portion 2011 and at least one lip portion extending out from the main portion 2011; in the presence of multiple lip portions, the multiple lip portions are sequentially connected to form a Z shape, one end of the innermost lip portion is connected to the main portion 2011, a reinforcing structure is arranged on the outermost lip portion, and the thickness of the outermost lip portion is greater than that of the other lip portions; a circular groove 101 is formed in the periphery of the oven opening of the oven, and the main portion 2011 is arranged in the circular groove 101 and provided with hollow structures 2012 which are spaced apart from each other, so that the main portion 2011 is able to deform to be fixed in the circular groove 101; when the door body 200 is closed, the outermost lip portion abuts against the inner side of the door body 200.

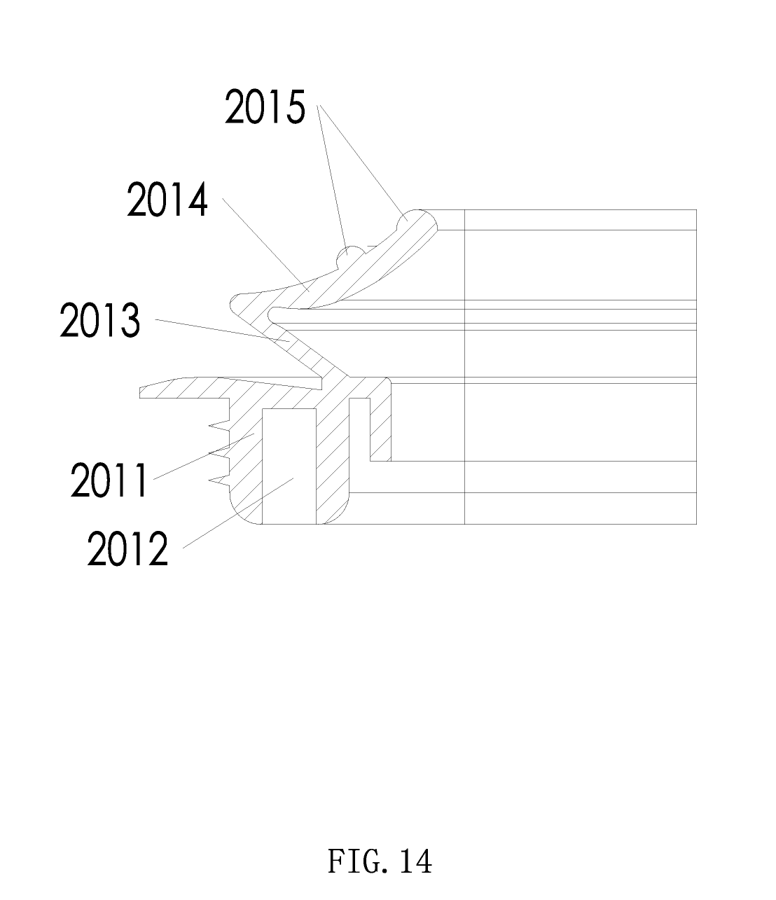

As shown in FIGS. 14-16, the main portion 2011 is provided with multiple hollow structures 2012 which are spaced apart from each other, so that the main portion 2011, when mounted in the circular groove 101, is able to deform to be fixed in the circular groove 101 stably (see FIG. 13) and will not be disengaged from the circular groove 101, which may otherwise compromise the sealing performance.

FIGS. 14-16 are schematic diagrams of the second sealing ring 201 in different structural forms. The second sealing ring 201 shown in FIG. 14 includes two lip portions, which are respectively a first lip portion 2013 directly connected to the main portion 2011 and a second lip portion 2014 connected to the first lip portion 2013, and a tail end, not connected to the first lip portion 2013, of the second lip portion 2014 forms a free end. Reinforcing ribs 2015 are arranged on at least one side of a portion close to the tail end of the second lip portion 2014 to improve the strength of the second lip portion 2014. Of course, the reinforcing ribs 2015 are not merely arranged on the portion close to the tail end of the second lip portion, and the number of the reinforcing ribs 20145 is not limited. In a pressure cooking mode, the presence of a pressure in the cooking cavity requires specific strength of the second lip portion 2014 of the sealing ring 201; in the presence of a pressure in the cooking cavity, a squeezing force will be applied to the second lip portion 2014 to enable the second lip portion 2014 to be close to the inner side of the door body 200 and withstand a specific pressure, as shown in FIG. 13.

To guarantee that the door body 200 is normally sealed in the case of pressureless cooking, the first lip portion 2013 is designed to be thin, that is, the thickness of the first lip portion 2013 is less than that of the second lip portion 2014, so that when the door body 200 is closed, the door body 200 may press the first lip portion 2013 of the second sealing ring 201, and the door body 200 is sealed in the absence of a pressure. It may be understood that in a case where the second sealing ring 201 includes more than two lip portions, all the lip portions, except the outermost lip portion which is close to and seals the door body 200, should be designed to be thin to ensure that the second sealing ring 201 deforms smoothly to be pressed under the action of the door body 200.

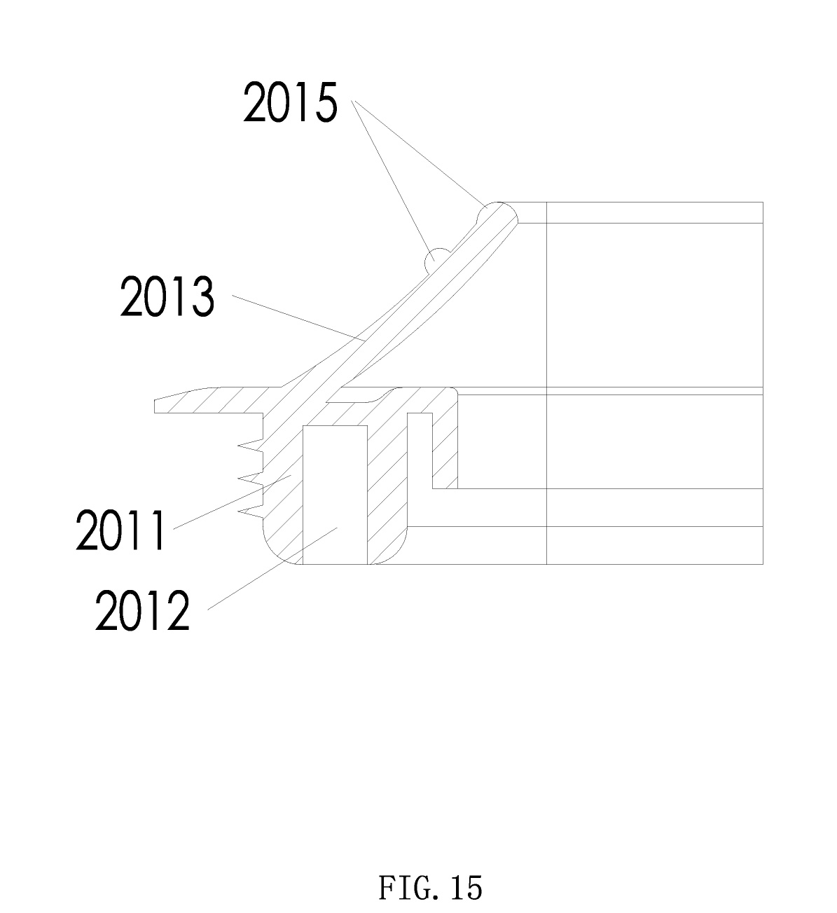

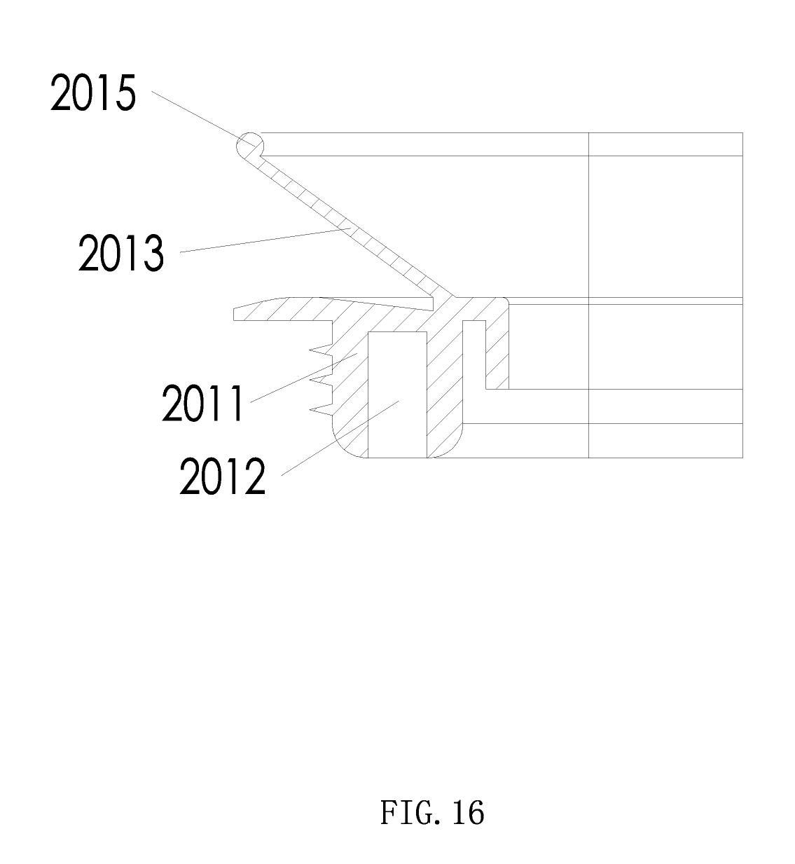

The second sealing ring 201 shown in FIGS. 15 and 16 is provided with only one lip portion, which is a first lip portion 2013. The first lip portion 2013 may extend in two opposite directions from different positions of the main portion 2011, reinforcing ribs 2015 are arranged on at least one side of a portion close to a tail end of the first lip portion 2013 to improve the strength of the first lip portion 2013. When the door body 200 is closed, the first lip portion 2013 is close to the inner side of the door body 200 and withstands a specific pressure.

As shown in FIG. 1, the pressure steam oven further includes a steam supply device 500, a heating device 600, a water supply device 700 and a cooling device 800. The steam supply device 500 selectively supplies steam into the cooking cavity as needed to cook food with the steam. A steam line is connected to the steam supply device 500, and the steam generated by the steam supply device 500 is transported into the oven body 100 by means of the steam line. The water supply device 700 supplies water to the steam supply device 500. The heating device 600 is used for heating the cooking cavity to bake food. The cooling device 800 is used for cooling the control module 103, the convection fan device 300 and the steam discharging and pressure relief device (which will be introduced below).

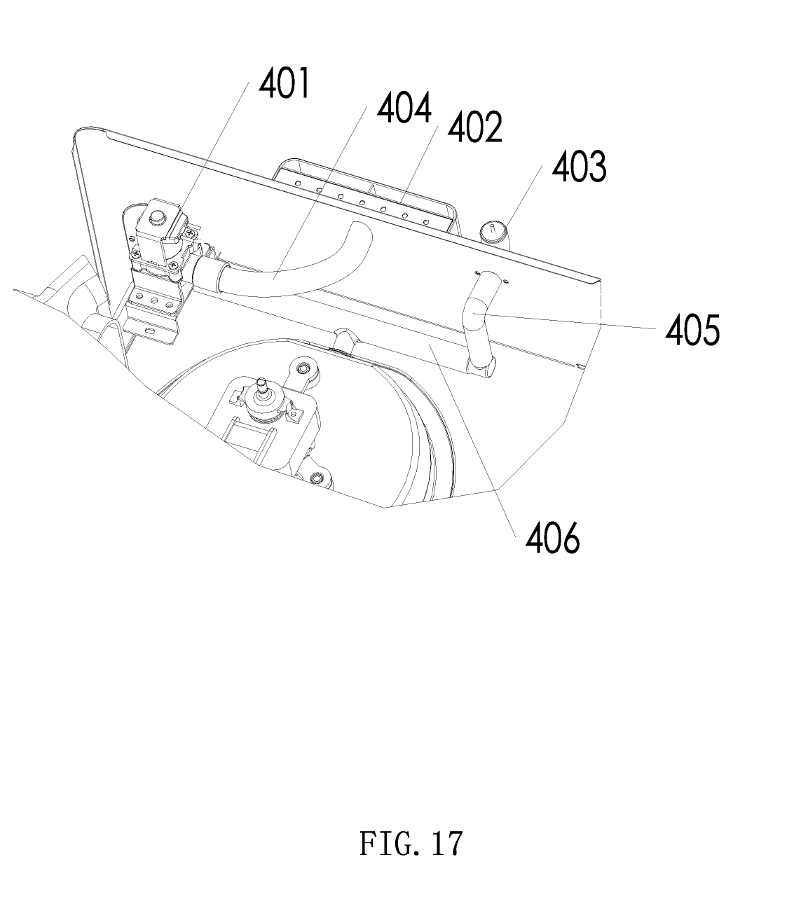

As shown in FIG. 17, the pressure steam oven further includes the steam discharging and pressure relief device. The steam discharging and pressure relief device includes a steam valve 401, a steam discharging part 402, a pressure relief part 403, a steam discharging line 404, a pressure relief line 405 and a steam inlet line 406. One end of the steam discharging line 404 is connected to an outlet of the steam valve 401, and the other end of the steam discharging line 404 is provided with the steam discharging part 402. The structure of the steam discharging part is not limited, for example, the steam discharging part may be a steam outlet for directly discharging steam. One end of the steam inlet line 406 is connected to an inlet of the steam valve 401, and the other end of the steam inlet line 406 is connected to one end of the pressure relief line 405. The other end of the pressure relief line 405 is provided with the pressure relief part 403, and a steam inlet communicating with an interior of the oven body 100 is formed in the steam inlet line 406.

In a case where the pressure cooking mode of the pressure steam oven is not enabled, the control module 103 controls the steam valve 401 to be powered off, the steam valve 401 is in an on state, the steam inlet line 406 is connected to the steam discharging line 404, steam from the oven body 100 enters the steam discharging line and is discharged by means of the steam discharging part, and cooking under normal pressure is maintained in the cooking cavity.

In a case where the pressure cooking mode of the pressure steam oven is enabled, the control module 103 controls the steam valve 401 to be powered on, the steam valve 401 is in an off state, the steam inlet line 406 is disconnected from the steam discharging line 404, and the steam in the oven body 100 (the cooking cavity) is discharged by means of the pressure relief part 403 only when the pressure in the cooking cavity reaches a set pressure, so that the pressure in the cooking cavity is increased to realize pressure cooking.

As shown in FIG. 1, the pressure steam oven further includes an evaporation device 900, the evaporation device 900 is arranged at a bottom of the interior of the oven body 100, and an evaporation surface of the evaporation device 900 is lower than a bottom surface of the interior of the oven body 100. When the pressure cooking mode or a pressure steaming mode of the pressure steam oven is enabled, condensate water may be generated, and in this case, the condensate water is collected onto the evaporation surface of the evaporation device 900 at the bottom of the oven body 100 and is evaporated, thus solving the problem that condensate water in the oven body 100 is difficult to remove.

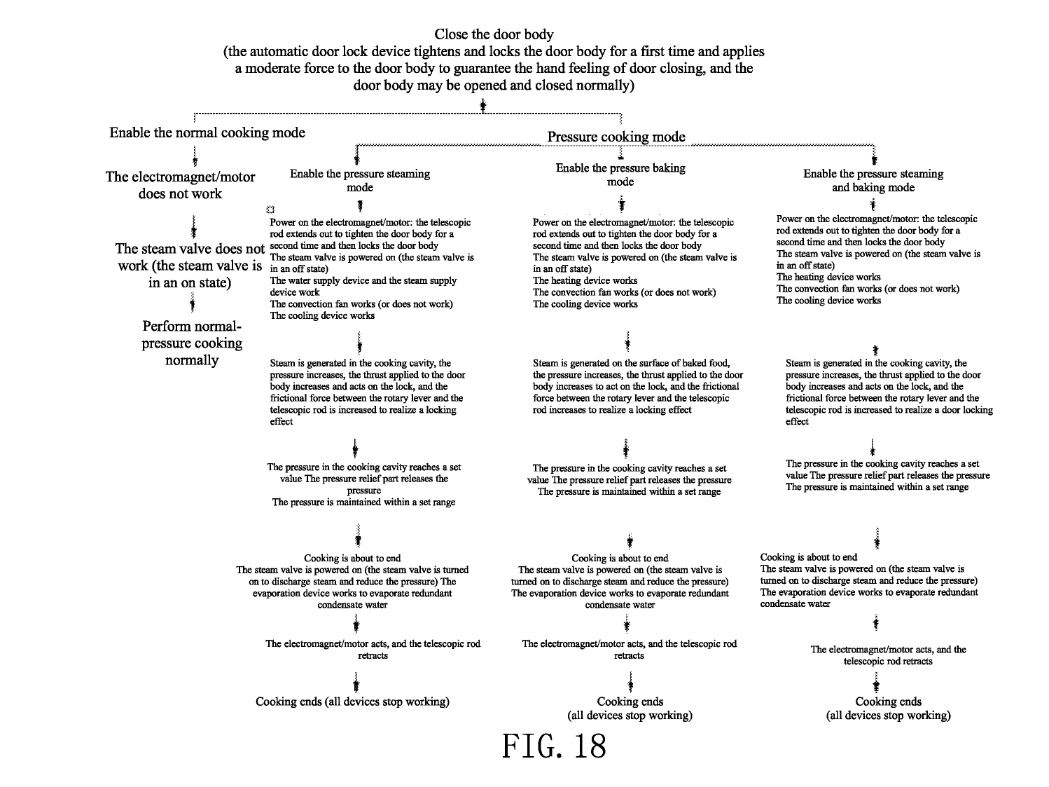

As shown in FIG. 18, the pressure steam oven in the embodiments of the present invention has different cooking modes, including normal cooking modes, a pressure steaming mode, a pressure baking mode, a pressure steaming and baking mode, etc. The normal cooking modes include a steaming mode under normal pressure, a baking mode under normal pressure and a steaming and baking mode under normal pressure.

The above description is illustrative rather than restrictive. Those ordinarily skilled in the art may make transformations, amendments, substitutions and modifications to the above embodiments within the scope of the present disclosure. The above examples (or, one or more schemes) may be combined for use, and the embodiments may be combined in various ways.

What is claimed is:

1. An automatic door lock device, applied to a pressure steam oven, wherein the automatic door lock device comprises:
a latch, arranged on an inner side of a door body of the pressure steam oven;
an engaging part, arranged on an oven body of the pressure steam oven and rotatable with respect to the oven body, wherein when the door body is closed, the engaging part is pushed to rotate in a first direction and is engaged in the latch, and when the door body is opened, the engaging part rotates in a second direction opposite to the first direction and is disengaged from the latch;
an elastic part, arranged on the oven body, acting on the engaging part and used for applying, to the engaging part, an acting force for enabling the engaging part to rotate in the first direction to tighten the latch when the door body is closed, and applying, to the engaging part, an acting force for enabling the engaging part to rotate in the second direction, so as to enable the engaging part to rotate and be maintained in an initial state when the door body is opened; and
a locking part, arranged on the oven body and used for stopping the engaging part to prevent the engaging part from rotating in the second direction when a pressure in the oven body reaches a first threshold, so that a lock applies, to the latch, a locking force towards an interior of the oven body.

2. The automatic door lock device according to claim 1, wherein the engaging part comprises a rotary lever and the lock arranged on the rotary lever, and the rotary lever is rotationally connected to the oven body; when the door body is closed, the lock is engaged in the latch; when the door body is opened, the lock is disengaged from the latch; the locking part is started when the pressure in the oven body reaches the first threshold and stops the rotary lever.

3. The automatic door lock device according to claim 2, wherein the rotary lever comprises a rotary connection portion as well as a first lever body and a second lever body which extend out from the rotary connection portion, the rotary lever is rotationally connected to the oven body by means of the rotary connection portion, a free end of the first lever body forms the lock, and a free end of the second lever body is used for stopping the locking part.

4. The automatic door lock device according to claim 3, wherein the locking part comprises a telescopic rod; when the pressure in the oven body reaches the first threshold, the telescopic rod stretches out towards the second lever body and is located in front of the second lever body in the second direction to prevent the rotary lever from rotating in the second direction.

5. The automatic door lock device according to claim 4, wherein a slope is arranged at the free of the second lever body; when the telescopic rod stretches out, the slope abuts against the telescopic rod to enable the telescopic rod to apply, to the second lever body by means of the slope, an acting force for enabling the second lever body to rotate in the first direction, so that the lock tightens the latch towards the interior of the oven body; when the telescopic rod stretches out in place, the telescopic rod crosses over the slope and stops the second lever body; when the steam pressure in the oven body pushes the door body outwards, the rotary lever is driven to tend to rotate in the second direction, and the second lever body applies a pressure to the telescopic rod to implement double locking.

6. The automatic door lock device according to claim 4, wherein the locking part further comprises an electromagnet fixed to the oven body, and the telescopic rod penetrates through the electromagnet; when the electromagnet is powered on or off, the telescopic rod stretches out towards the rotary lever; when the electromagnet is powered off or on, the telescopic rod retracts.

7. The automatic door lock device according to claim 4, wherein the locking part further comprises a motor and a cam which is arranged on an output shaft of the motor and rotates with the output shaft; when the cam rotates, the cam pushes the telescopic rod to stretch out towards the rotary lever or stops pushing the telescopic rod to allow the telescopic rod to retract and give way for rotation of the rotary lever.

8. The automatic door lock device according to claim 7, wherein the locking part further comprises a reset part and a microswitch, and the reset part has an end connected to the oven body as well as an end connected to the telescopic rod and is used for applying, to the telescopic rod, an acting force for enabling the telescopic rod to return to a retracted state; the microswitch is arranged on the oven body and electrically connected to the motor, and when the telescopic rod stretches out in place towards the rotary lever under the action of the cam, the microswitch is triggered to stop the motor and at the same time, drive the reset part to stretch to accumulate elastic potential energy.

9. The automatic door lock device according to claim 2, wherein the elastic part comprises a torsion spring, and the torsion spring has an end arranged on the rotary lever as well as an end arranged on the oven body.

10. A pressure steam oven, comprising an oven body and a door body, a cooking cavity being formed in the oven body, the oven body being provided with an oven opening connected to the cooking cavity, and the door body being used for opening or closing the oven opening, wherein the pressure steam oven further comprises the automatic door lock device according to claim 1.

11. The pressure steam oven according to claim 10, further comprising a convection fan device, wherein the convection fan device comprises a convection fan, convection blades, a convection blade housing and a first sealing ring, the convection fan is fixed to the oven body, the convection blade housing is arranged outside the convection blades and used for separating the convection fan from the convection blades, an output shaft of the convection fan penetrates through the convection blade housing to be connected to the convection blades and is used for driving the convection blades to rotate, the convection blades, when rotating, drive hot air in the oven body to circulate, the first sealing ring is disposed around the output shaft and has an end abutting against the convection blade housing as well as an end abutting against a fan body of the convection fan.

12. The pressure steam oven according to claim 10, further comprising a second sealing ring, wherein the second sealing ring comprises a ring-shaped main portion and at least one lip portion extending out from the main portion; in the presence of multiple lip portions, the multiple lip portions are sequentially connected to form a Z shape, an end of the innermost lip portion is connected to the main portion, a reinforcing structure is arranged on the outermost lip portion, and a thickness of the outermost lip portion is greater than that of the other lip portions; a circular groove is formed in a periphery of the oven opening of the oven, the main portion is arranged in the circular groove and provided with hollow structures which are spaced apart from each other, so that the main portion is able to deform to be fixed in the circular groove; when the door body is closed, the outermost lip portion abuts against an inner side of the door body.

13. The pressure steam oven according to claim 10, further comprising a steam discharging and pressure relief device, wherein the steam discharging and pressure relief device comprises a steam valve, a steam discharging part, a pressure relief part, a steam discharging line, a pressure relief line and a steam inlet line, the steam discharging line has an end connected to an outlet of the steam valve as well as an end provided with the steam discharging part, the steam inlet line has an end connected to an inlet of the steam valve as well as an end connected to one end of the pressure relief line, the other end of the pressure relief line is provided with the pressure relief part, and a steam inlet connected to an interior of the oven body is formed in the steam inlet line;
in a case where a pressure cooking mode of the pressure steam oven is not enabled, the steam valve is powered off and is in an on state, the steam inlet line is connected to the steam discharging line, and steam in the oven body is discharged by means of the steam discharging part;
in a case where the pressure cooking mode of the pressure steam oven is enabled, the steam valve is powered on and is in an off state, the steam inlet line is disconnected from the steam discharging line, and the steam in the oven body is discharged by means of the pressure relief part when reaching a set pressure.

14. The pressure steam oven according to claim 10, further comprising an evaporation device, wherein the evaporation device is arranged at a bottom of an interior of the oven body, and an evaporation surface of the evaporation device is lower than a bottom surface of the interior of the oven body.
